(19) United States
(12) Patent Application Publication
(10) Pub. No.: US 2009/0230247 A1
(43) Pub. Date: Sep. 17, 2009

(54) METHODS AND APPARATUS FOR INCORPORATING LUMINOPHORES INTO DECORATIVE LAMINATES

(76) Inventor: John N. Harris, Seattle, WA (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 12/049,675

(22) Filed: Mar. 17, 2008

(51) Int. Cl. B64C 1/00; C09K 11/70; C09K 11/64; C09K 11/57

(52) U.S. Cl. 244/133; 252/301.4 R

(57) ABSTRACT

A process for incorporating light emitting materials into aircraft interiors is described. The method includes selecting at least one light emitting material, incorporating the selected at least one light emitting material into one or more of a laminate coating and an extruded component, and installing the one or more of a laminate coating and extruded component into an aircraft cabin configuration.

### BACKGROUND OF THE INVENTION

The field of the invention relates generally to lighting of interior spaces, and more specifically, to methods and apparatus for incorporating luminophores and other luminescent materials into decorative laminates.

Within a typical commercial aircraft, there are ceiling lights as well as overhead lights at each seat to provide a large percentage of the interior lighting for the aircraft cabin. This configuration for lighting the interior of these commercial aircraft could be improved, both for safety and comfort of both crew and passengers. However, addition of additional lighting fixtures results in additional power consumption, which in turn requires that additional electric be generated on the aircraft. A significant amount of energy goes into lighting the interior of aircraft that incorporate current lighting configurations.

Generally, luminophores refer to an atom or atomic grouping that, when present in a compound, increases the ability of the compound to luminesce. Also generally, luminescence refers to light from nonthermal sources, that is a light emission not due to incandescence and occurring at low temperatures. Certain luminophores absorb ultraviolet (UV) light, near UV light, and visible light. The absorption of a photon of excitation light results in the emission of a photon of visible light. The period of time required for the emission of the photon is referred to as the luminescence lifetime. The length of the luminescence lifetime is proportional to the probability of a transition back to a ground electronic state and can range from a few nanoseconds to several hundreds of seconds.

In one previous application, organic luminophores were incorporated into laundry soap and were absorbed into the clothing as the wash cycle was completed. These particular luminophores absorbed light in the UV range, and then emitted light in the visible range giving the clothing a brighter appearance. With the organic luminophores, the results were temporary and the bright appearance faded quickly over time.

Such technologies have been utilized previously to develop luminescent lamps or cathodoluminescent screens that provide white or near-white light. However, it should be noted that emissions from blue and blue-green luminescent emitters also enhance ambient light or brightness.

### BRIEF DESCRIPTION OF THE INVENTION

In one aspect, a process for incorporating light emitting materials into aircraft interiors is provided. The method includes selecting at least one light emitting material, incorporating the selected at least one light emitting material into one or more of a laminate coating and an extruded component, and installing the one or more of a laminate coating and extruded component into an aircraft cabin configuration.

In another aspect, a component operable as a portion of an aircraft cabin is provided. The component includes an aircraft cabin structural component, a decorative laminate applied to the aircraft cabin structural component, and a coating applied to the decorative laminate, the coating including at least one light emitting material.

In still another aspect, a thermoplastic compound for production of aircraft interior components is provided. The compound includes a plastic capable of extrusion into aircraft interior components, at least one of a luminescent material, a phosphorescent material, and a combination of luminescent and phosphorescent materials, and a scattering pigment configured to increase an emission intensity of the luminescent and/or phosphorescent materials.

### BRIEF DESCRIPTION OF THE DRAWINGS

FIG. 1 is a graph illustrating vibrational relaxation and luminescence as they relates to electronic and vibration energy states.

FIG. 2 is a diagram illustrating the luminescent process in a semiconducting material.

FIG. 3 is a flowchart illustrating a method for incorporating luminophores and phosphors into materials that are used in the manufacture of aircraft interiors.

### DETAILED DESCRIPTION OF THE INVENTION

The described embodiments generally relate to luminophores, luminescent materials, and/or phosphorescent materials, that are incorporated into decorative laminate coatings which are applied to sidewalls, storage bins, and ceiling panels of commercial aircraft to provide additional sources of interior lighting. Additional embodiments include plastics having luminophores directly incorporated therein. Such plastics may also be incorporated into the interior of an aircraft. In particular, certain solid state phosphors are well suited for such applications as they are capable of tolerating the high processing temperatures utilized in the production of such plastics.

In a typical aircraft configuration, there are two sources of light, light that comes into the plane from the exterior (through windows and doors), and interior lighting. Generally, this type of incident light is partially absorbed by the materials within the airplane interior. More specifically, currently used decorative laminates do not reflect all incident light. Rather, some of the incident light is absorbed by the coating, which later loses the added energy as heat.

As described above, luminophores absorb ultraviolet (UV) light, near UV light, and visible light. By incorporating luminophores, for example, into certain decorative laminates used within an aircraft interior, they will absorb at least some of this incident light and therefore emit visible light, making the airplane interior brighter. In other words, absorption of incident light and emission of visible light by the luminescent material within decorative laminate coatings allows sources of incident light to be used more efficiently since many luminophores, luminescent materials, and phosphorescent materials can emit for long periods of time after an incident light source has been removed.

Some luminophores cannot be incorporated into coatings that contain metal pigment as this process quenches the luminescence. One disadvantage of inorganic phosphors, which is one class of luminescent material, is that it can be difficult to disperse this material uniformly within a coating formulation. At least some of this difficulty is overcome through methods used to characterize the distribution of particle size and separate it into a usable range of sizes. There are also numerous pigment grinding methods that can be used to generate a size distribution within the nominal range of pigment diameters. These methods include wet ball milling, three roller mill, stone mill, sand mill, and shot mill. In addition, once a pigment has been dispersed it needs to be stabilized through the use additives that wet its surface area and prevent agglomeration. There are commercial methods of pigment dispersion and stabilization that are mature and readily available for this process.

Current decorative laminate coatings incorporate colored pigments and do not use luminescent materials. However, there are a large variety of luminescent materials that can be effectively incorporated into decorative laminate coatings. Many of these luminescent materials impart different optical characteristics and by adding these various materials in defined amounts, a product is tailored to a desired outcome. One example of such a desired outcome is a specific level and spectrum of visible light. In an aircraft interior application, the amount of visible light within the cabin is increased. If increased brightness is desired in a specific spectrum, a specific type or set of luminophores can be incorporated into the decorative laminates utilized within the cabin.

In one embodiment, a permanent coating that contains one or more luminophores is applied to a decorative laminate in the same manner that some coatings are currently being applied, for example, using silk screening. The luminophores described below and used in this silk screening process are extremely stable under UV light and near UV light and should not diminish in effectiveness over time. In addition to increasing the overall brightness of an area, the described processes are capable of use in the generation of lighting scenarios that appeal to different moods. Specifically, the luminophores used in the above described coatings, and other applications, can be tailored to emit blue, green, yellow, orange, red, or even white light. In additional embodiments, phosphorescent materials can also be incorporated, resulting in a configuration that emits visible light for long periods of time after a light source has been removed.

The optical properties of a material are defined by how light energy is absorbed, transmitted, reflected, and scattered. The light energy present in the materials currently utilized in airplane interiors is at least partially absorbed by these materials and coatings. As such, this energy is ultimately lost to the surroundings as heat. Through incorporation of luminescent and/or phosphorescent materials into these components and coatings, a greater tendency to emit light, rather than heat, is achieved. In one embodiment, luminescent material is incorporated into a coating and combined with an amount of a scattering pigment, such as titanium dioxide or TiO2, to maximize the emission intensity. The scattering pigment is included to increase the probability that a photon of exciting light will be absorbed by the luminescent material.

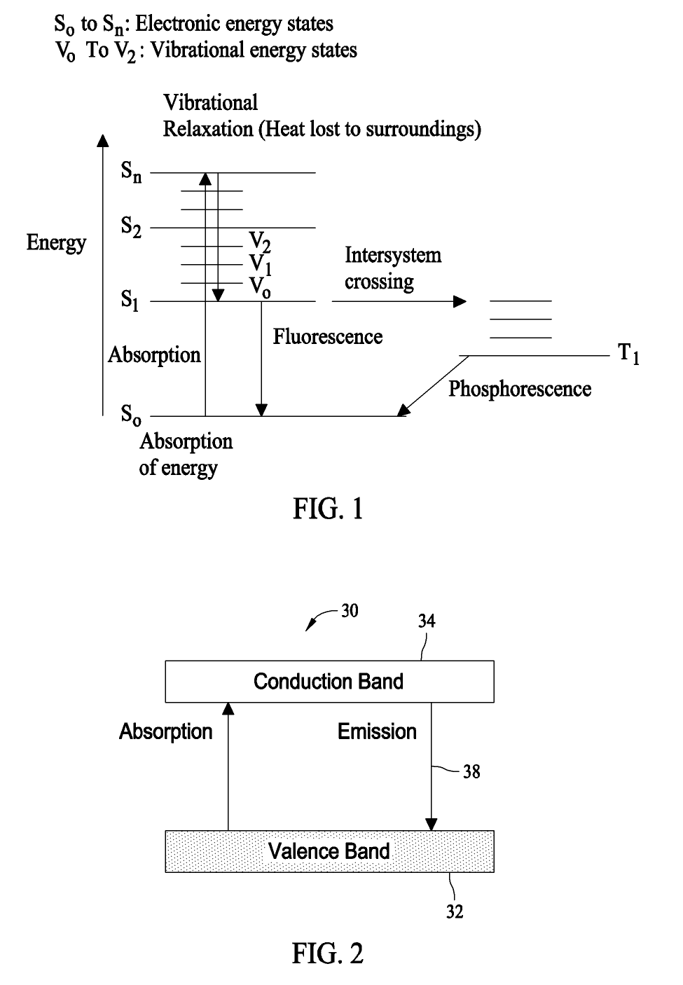

The difference between light and heat emission is primarily due to the gap between excited electronic energy states within the luminescent and/or phosphorescent materials. Excitation for any material occurs with the absorption of light energy. Once excited, a material will relax to the ground state through a vibration pathway. This vibration pathway involves vibration energy states that are fairly close to one another, resulting in the release of heat to the surroundings. However, larger gaps between the electronic energy states make it more difficult for a vibration de-excitation state to occur, thereby increasing the probability that relaxation in the energy state will occur with the emission of a photon of light energy. This difference in these electronic and vibration energy states is illustrated by the graph 10 of FIG. 1.

The incorporation of luminophores and other light emitting materials into components and decorative laminate coatings will result in an increased efficiency in the lighting of aircraft interiors. A lesser amount of absorbed light is converted to heat and the additional light creates the appearance of a brighter airplane interior.

When light energy is absorbed by a material, a transient situation occurs in which some or all of the localized electrons are promoted into higher energy states. Over a period of time (spanning roughly that of a pico-second) the “excited” material relaxes back to the lowest excited electronic energy state, which is denoted by S1 in FIG. 1, and referred to as a singlet state. At this point there are different pathways for relaxation to occur. The energy may be lost to the surroundings as additional heat or it may be lost through the emission of a photon of light. This latter process is referred to as photoluminescence. FIG. 1 pictorially represents the absorption of energy and photoluminescence. Once energy is absorbed and the lowest excited energy state is populated then photoluminescence may occur.

Most organic molecules exist as ground-state singlets in which all electrons are paired. Because photo excitation causes the promotion of only a single electron, two singly occupied orbitals are produced upon excitation. If the electronic transition takes place without a spin inversion, these two electrons have opposite spins, and a singlet excited state is produced. The number of unpaired electrons in a molecule determines its multiplicity: a molecule with no unpaired spins is a singlet; one with one unpaired spin is a doublet; one with two unpaired spins is a triplet; one with three unpaired spins is a quartet, and so forth. When an electronic transition takes place with a spin inversion, the two singly occupied orbitals are populated by electrons with parallel spins, producing a triplet excited state. Spin restrictions forbid spin inversion during excitation, and only singlet-singlet electronic transitions are easily observed spectroscopically. After excitation, however, a change in state multiplicity can take place by a process called intersystem crossing. If the emission of a photon occurs without a change in its spin multiplicity the process is referred to as fluorescence, with a lifetime for the emission around 10⁻⁹ sec. On the other hand, if there is a change in spin multiplicity the emission process is referred to as phosphorescence. The change in the spin state is also a forbidden process and, consequently, the lifetime for a phosphorescent emission to occur is significantly longer.

There are also inorganic materials that exhibit luminescence. Unlike organic molecules these materials are typically crystalline solids that can be commonly referred to as large band gap semiconductors or doped insulators.

FIG. 2 is a diagram 30 illustrating the luminescent process in semiconducting material. Semiconducting materials are normally characterized by covalent bonding between all of the atoms of the material. In this bonding the wave functions of the outer electrons on individual atoms overlap each other, and it is no longer possible to associate electrons with a particular atom. As a result of this delocalization, electrons will exhibit some mobility in orbitals that are partially occupied. This is an important characteristic of these materials. The host lattice is semiconductors can also be thought of as an assemblage of interacting atoms. Owing to the magnitude of atoms in this assemblage there will be an enormous number of energy sublevels available at all allowed levels. Since the value of the energy sublevels are extremely close, the net effect is to form bands at each energy level which consist of a myriad number of discreet sublevels lying very close to another. These bands are separated by energy gaps in which no electronic states would exist. The highest energy band that the electrons completely fill is known as the valence band 32 and the partially or completely unoccupied energy band above it is known as the conduction band 34. The energy gap separating these two bands usually corresponds to a visible or near infrared photon. When these materials are excited with enough energy to promote an electron from the valence band 32 to the conduction band 34 it can lead to the emission 38 of a photon when the material relaxes back down to the ground state as shown in FIG. 2.

Doped insulators are crystalline solids used to host transition metal or rare earth metal ions. In the absence of these metal ions the insulators are optically inert and appear as a transparent or translucent material. This optical property is the result of an energy gap separating the ground and lowest excited state that corresponds to an ultraviolet photon. Insulating materials may be modified, however, through substitution and insertion into their crystal lattice a small amount of a metal ion. These metal ions, which are referred to as dopants, may possess electronic levels that are separated by an energy gap corresponding to a photon of visible light. The luminescence observed from such materials is usually associated with these metal ions.

As mentioned above, the types of luminophores and other light emitting materials incorporated into components and decorative laminate coatings can be used to tailor the light being emitted to any region in the visible light spectrum. Therefore it is possible to enhance mood lighting within the airplane interior, based upon the position within the visible spectrum of the incorporated materials. With the use of light from luminophores, other luminescent, and/or phosphorescent materials within an aircraft cabin it might be possible to reduce the overall amount of powered lighting within the cabin, for example, the amount of lighting above the main aisle might be reduced.

The following descriptions relate to the compositions of materials that might incorporate one or more luminophores, luminescent materials and/or phosphorescent materials for the purpose of increasing an amount of light within an aircraft interior, or cabin. The incorporated materials can impart changes to the surroundings in terms of the color of light that is emitted. One embodiment of decorative laminate coating includes, in addition to the luminescent materials and/or phosphorescent materials, a polymer (binder), additional pigments for coloration or visual effects (such as pearlescent pigment), and a solvent system, which is needed to optimize the flow of the coating during application.

The following specifically refers to various luminescent materials and/or phosphorescent materials that can be utilized in such coatings. The list is not exhaustive, and other embodiments are contemplated. For blue light emissions, the following materials are considered: BaMg₂Al₁₆O₂₇:Eu²⁺ and (Sr,Ca,Ba)₁₀(PO₄)₆Cl₂:Eu²⁺. Both of these phosphors strongly absorb near-UV light and provide a moderate amount of light in the visible range between 400-440 nm. For blue-green light emissions 2SrO.0.84P₂O₅.0.16B₂O₃:Eu²⁺ and Sr₂Si₃O₈.2SrCl₂:Eu²⁺ are considered. 6MgO.As₂O₅:Mn⁴⁺ is a red light emitter.

A combination of blue, blue-green, and red emitters will provide an overall appearance of white to blue-white light. Moreover, the desired color of emission can be tailored merely by changing the relative percentages of each phosphor component.

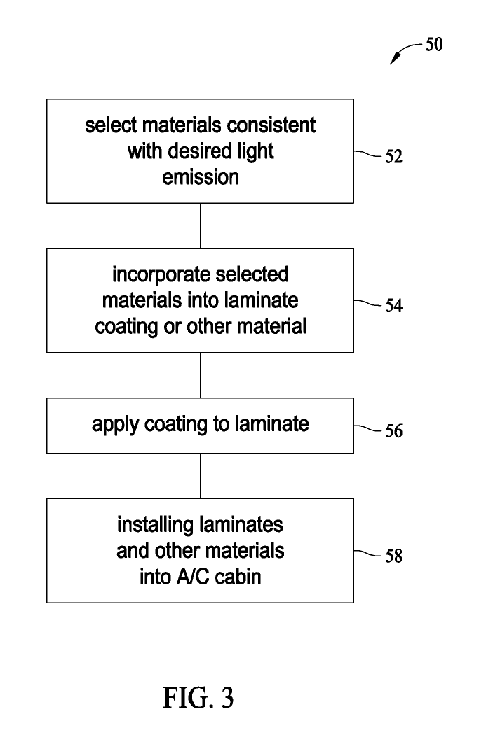

The above descriptions result, in part, in a process for fabricating decorative laminate coatings for utilization within aircraft interiors as is illustrated by the flowchart 50 of FIG. 3. Specifically, the process includes selecting 52 at least one luminophore material consistent with the desired light emission, incorporating 54 the selected luminophore materials into a laminate coating, applying 56 the coating to the decorative laminate, and incorporating 58 the coated decorative laminate into an aircraft cabin configuration.

The incorporation of luminescent and/or phosphorescent materials into plastics can be accomplished during the extrusion of the plastic, which will exert a large shearing force on these additional materials. Therefore, the incorporation of luminescent and/or phosphorescent materials into extruded plastics affects, to some degree, their mechanical properties. In one embodiment, in addition to the incorporation of luminescent material into the plastic, an optimal amount of a scattering pigment is utilized to maximize the emission intensity. An example of such a scattering material is titanium dioxide or TiO2. The scattering pigment is included to increase the probability that a photon of exciting light will be absorbed by the luminescent material.

In summarizing the above described embodiments, current decorative laminate coatings and other aircraft cabin components do not use luminescent or phosphorescent materials. The optical properties of such materials are defined by how light energy is absorbed, transmitted, reflected, and scattered. In the aircraft interior application, the light energy present in the airplane interior will normally be absorbed by these coatings and materials and is ultimately lost to the surroundings as heat. Of course, the described embodiments, while described in the context of aircraft interior lighting, should not be construed as limiting. The various applications in which these embodiments can be incorporated is expansive.

As mentioned elsewhere herein, there are a wide variety of both organic and inorganic materials that are available that exhibit luminescent properties. Many of these luminescent materials are suitable for incorporation into a decorative laminate, a coating for the decorative laminate, a thermoplastic panel, or a thermoset panel. Many of these materials impart different optical characteristics and combinations of these materials are tailorable to provide a desired outcome. For example, if increased brightness is desired a specific type or set of luminophores can be incorporated into a specific decorative laminate design.

By incorporating one or both of luminescent materials and phosphorescent materials into laminate coatings and other materials used within aircraft interiors, a greater tendency to emit light that has been absorbed is exhibited, rather than emission of heat. This difference is primarily due to the different gaps between excited electronic energy states within luminescent center and non-luminescent materials.

Excitation for any material occurs with the absorption of light energy. Once excited, a material will relax to the ground state through vibration, for example, through a vibrational pathway. This pathway involves vibrational energy states that are fairly close to one another. The vibrations in non-luminescent materials result in heat being released into the surroundings. However, larger gaps between the electronic energy states in luminescent and phosphorescent materials makes it more difficult for vibrational de-excitation to occur, increasing the probability that relaxation will occur with the emission of a photon of light energy.

While the invention has been described in terms of various specific embodiments, those skilled in the art will recognize that the invention can be practiced with modification within the spirit and scope of the claims.

What is claimed is:

1. A process for incorporating light emitting materials into aircraft interiors, said method comprising:
selecting at least one light emitting material;
incorporating the selected at least one light emitting material into one or more of a laminate coating and an extruded component; and
installing the one or more of a laminate coating and extruded component into an aircraft cabin configuration.

2. A method according to claim 1 wherein incorporating the selected at least one light emitting material comprises incorporating the selected at least one light emitting material into a laminate coating.

3. A method according to claim 2 further comprising applying the laminate coating to a decorative laminate.

4. A method according to claim 1 wherein selecting at least one light emitting material comprises selecting and combining the luminescent materials based on at least one of optical characteristics, durability, stability, length of light emissions, and flammability.

5. A method according to claim 1 wherein selecting at least one light emitting material comprises selecting one ore more luminescent materials for the purpose of increasing brightness within an enclosed area of an aircraft cabin.

6. A method according to claim 1 further comprising selecting a lighting configuration for the aircraft cabin that enhances emissions from the selected at least one light emitting material.

7. A method according to claim 1 wherein incorporating the selected at least one light emitting material comprises selecting a binder a pigment, and a solvent for the laminate coating that is compatible with the selected at least one light emitting material.

8. A method according to claim 1 further comprising:
characterizing a distribution of particle sizes for the at least one light emitting material; and
separating the at least one light emitting material into a usable ranges of sizes.

9. A method according to claim 1 further comprising incorporating a pigment grinding method to generate a size distribution for the at least one light emitting material.

10. A method according to claim 1 wherein selecting at least one light emitting material comprises selecting one or more light emitting materials that emit light within a specific color spectrum.

11. A component operable as a portion of an aircraft cabin, said component comprising:
an aircraft cabin structural component;
a decorative laminate applied to said aircraft cabin structural component; and
a coating applied to said decorative laminate, said coating comprising at least one light emitting material.

12. A component according to claim 11 wherein said at least one light emitting material is stable when exposed to ultraviolet and near ultraviolet light.

13. A component according to claim 11 wherein said at least one light emitting material is selected based on at least one of optical characteristics, durability, stability, length of light emissions, and flammability.

14. A component according to claim 11 wherein said at least one light emitting material is selected for the purpose of increasing brightness within an enclosed area of an aircraft cabin.

15. A component according to claim 11 where, in addition to said at least one light emitting material, said coating comprises:
a binder;
a pigment; and
a solvent that is compatible with said at least one light emitting material.

16. A component according to claim 11 wherein said at least one light emitting material comprises light emitting materials that emit light within a specific color spectrum.

17. A component according to claim 11 wherein said at least one light emitting material is subjected to a pigment grinding process to generate a size distribution for particles that constitute said at least one light emitting material.

18. A component according to claim 11 wherein said coating is applied to said decorative laminate using a silk screen process.

19. A component according to claim 11 wherein said coating comprises a scattering pigment operable to increase the probability that a photon of incident light will be absorbed by said at least one light emitting material.

20. A thermoplastic compound for production of aircraft interior components, said compound comprising:
a plastic capable of extrusion into aircraft interior components;
at least one of a luminescent material, a phosphorescent material, and a combination of luminescent and phosphorescent materials; and
a scattering pigment configured to increase an emission intensity of said materials.
